(19) United States
(12) Patent Application Publication
(10) Pub. No.: US 2014/0249832 A1
(43) Pub. Date: Sep. 4, 2014

(54) REMS MANAGEMENT TOOL

(71) Applicant: FDA REMS, LLC, Chagrin Falls, OH (US)

(72) Inventor: Marie Link, Chagrin Falls, OH (US)

(73) Assignee: FDA REMS, LLC, Chagrin Falls, OH (US)

(21) Appl. No.: 13/782,765

(22) Filed: Mar. 1, 2013

(51) Int. Cl. G06Q 50/22; G06Q 30/00

(52) U.S. Cl. CPC G06Q 50/22; G06Q 30/018
USPC 705/2

(57) ABSTRACT

The various technologies presented herein relate to assisting a prescriber in obtaining and maintaining Risk Evaluation and Mitigation Strategy (REMS) compliance. A centralized approach is presented for obtaining REMS compliance data from a drug manufacturer, federal regulator, etc., and based on identifying one or more REMS medications associated with a prescriber, compliance of the prescriber with regard to the REMS compliance data for the one or more REMS medications can be determined. Interaction and notifications, etc., can be performed utilizing internet access. In the event of a prescriber failing a compliance requirement, one or more actions can be identified to facilitate bringing the prescriber into REMS compliance. REMS compliance data can be shared with the drug manufacturer, regulatory body, etc., to facilitate understanding of success of REMS compliance. Stored REMS compliance data can be forwarded to a third party.

### TECHNICAL FIELD

This disclosure relates to managing compliance with pharmaceutical safety requirements, such as U.S. Food and Drug Administration (FDA). Risk Evaluation and Mitigation Strategies (REMS).

### BACKGROUND

At a basic level, prescribing a REMS medication (differentiation from a non-REMS medication) may simply require a medication guide and any other pertinent information to be provided to a patient (e.g., in accord with a communication plan). However, some medications (e.g., opioids) may require further management with regard to dangerous side-effects, potentially harmful interactions with other medications, drug abuse potential, etc. Hence, while some medications are approved by governmental bodies for use, there may be additional limitations and requirements placed on the manufacturer and prescriber for permissible use of these medications.

The Food and Drug Administration Amendments Act (FDAAA) of 2007 provided the FDA with expanded authority to require Risk Evaluation and Mitigation Strategies (REMS) from manufacturers and prescribers to ensure that the benefits of a medication, drug, or biological product outweigh risks associated with its use. FDA REMS promote appropriate use and safe management of those medications that have a higher risk of harm compared to other medications. REMS programs are directed at drug manufacturers and prescribers in the United States of America with the intent to decrease the number of harmful events related to use of a subset of nationally prescribed medications that have been correlated with a higher incidence of patient harm and death. Along with the aforementioned medication guide and communication plan, an “Elements to Assure Safe Use” (ETASU) program has been developed as part of the REMS program, whereby ETASU requirements and REMS regulations in general may require a prescriber to indicate any of the following: they have a certificate of education/training or specific experience/knowledge required to prescribe a medication(s), they can diagnose a condition for which the medication is directed towards, they understand the risks and benefits of a medication and communicate these risks to the patient(s), they have read the drug/prescribing information materials associated with the medication, they can diagnose and treat a potential adverse reaction to the medication, they have communicated to the patient any associated risk and/or benefits regarding the medication, they periodically recertify and re-enroll in an ETASU/REMS program, they agree to terms of a prescription and any associated manner of issuance regarding a prescription (e.g., required to receive prior-authorization, check ‘qualification stickers’, dispense within a pre-determined amount of time, complete prescriptions only from an enrolled physician, conduct patient monitoring, etc.), and the like.

REMS programs and ETASU requirements can be highly complex, may not be published in a coordinated manner, are not standardized, are modified frequently and communication of changes may not be apparent. Such circumstances leave prescribers at a disadvantage when it comes to understanding what they need to do to be compliant with a particular REMS program or ETASU requirement. Currently, there are approximately 100 medications that require one or more REMS elements of compliance and that number can change at any time as medications are added or removed from the list of drugs requiring REMS program compliance. Certain REMS requirements require a prescriber to be formally certified by the drug manufacturer/drug sponsor, whereby non-certified prescribers are not able to receive a REMS medication for which certification has been obtained. Currently, penalty for non-certified prescribers is unknown, where a majority of prescribers are not certified and, hence, are not restricted from obtaining or prescribing a REMS medication.

### SUMMARY

The following is a brief summary of subject matter that is described in greater detail herein. This summary is not intended to be limiting as to the scope of the claims.

The various, exemplary, non-limiting embodiments presented herein relate to facilitate assisting a prescriber in obtaining and maintaining compliance with REMS programs. In an exemplary, non-limiting embodiment, the REMS system can include a computerized REMS compliance component configured to receive information from a prescriber, wherein the information relates to REMS compliance for a medication. The computerized REMS compliance component also being configured to determine a REMS compliance status for the prescriber for the medication, wherein the determination is based at least in part on comparison of the received prescriber information and at least one REMS compliance regulation. In another embodiment, the REMS compliance component can notify a requester, based on the determination, whether the prescriber satisfies the REMS compliance regulation for the medication.

A further exemplary, non-limiting embodiment that comprises a method for obtaining and maintaining REMS compliance is presented. The method comprising receiving a REMS compliance requirement request from a prescriber, and based on the REMS compliance requirement request, determining a REMS element of compliance requirement for a medication of interest to the prescriber, and further notifying the prescriber of the REMS compliance requirement for the medication.

In a further exemplary, non-limiting embodiment a processor can be utilized to control operation of a REMS system for obtaining and maintaining REMS compliance for a prescriber. Controlling by the processor can include receiving a REMS compliance requirement request from a prescriber and based on the REMS compliance requirement request, determining a REMS compliance requirement for a medication of interest to the prescriber. Further, based on information received from the prescriber relating to completion of the REMS compliance requirement, determining whether the prescriber satisfies the REMS compliance requirement for the medication and notifying the prescriber of satisfying or failing to satisfy the REMS compliance requirement for the medication.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a block diagram illustrating exemplary, non-limiting embodiments to facilitate REMS compliance.

FIG. 2 is a flow diagram illustrating an exemplary, non-limiting embodiment for facilitating REMS compliance.

FIG. 3 is a flow diagram illustrating an exemplary, non-limiting embodiment for operating a REMS compliance system.

FIG. 4 is a flow diagram illustrating an exemplary, non-limiting embodiment for assisting and monitoring compliance of a prescriber with a REMS regulation.

FIG. 5 is a flow diagram illustrating an exemplary, non-limiting embodiment for assisting and monitoring compliance of a prescriber with a REMS regulation.

FIG. 6 is a flow diagram illustrating an exemplary, non-limiting embodiment for distributing a REMS regulation(s).

FIG. 7 is a flow diagram illustrating an exemplary, non-limiting embodiment for reporting REMS compliance.

FIG. 8 is a flow diagram illustrating an exemplary, non-limiting embodiment for assisting a practitioner in REMS compliance.

FIG. 9 is a flow diagram illustrating an exemplary, non-limiting embodiment for prioritizing a work-list associated with a plurality of REMS regulations.

FIG. 10 is a flow diagram illustrating an exemplary, non-limiting embodiment for facilitating access of REMS regulation information associated with a prescriber.

FIG. 11 is a flow diagram illustrating an exemplary, non-limiting embodiment for identifying one or more medications based on prescriber specialty.

FIG. 12 is a flow diagram illustrating an exemplary, non-limiting embodiment for reporting REMS compliance.

FIG. 13 is a flow diagram illustrating an exemplary, non-limiting embodiment for facilitating REMS compliance.

FIG. 14 illustrates an exemplary computing device.

### DETAILED DESCRIPTION

The various, exemplary, non-limiting embodiments presented herein relate to generation and compliance with various regulations, etc., relating to REMS requirements for an identified REMS medication(s). Various embodiments are disclosed herein to facilitate prescribers or prescriber-affiliated organizations to investigate and manage medication safety requirements such as a REMs requirement(s). In an embodiment, a single source certification management system is provided to enable a prescriber to manage a REMS requirement(s) for at least one medication having an ETASU certification/educational training requirement. Single sourcing enables a plurality of REMS information to be accessed from one location. Rather than having to look up FDA publications and/or manufacturer publications for each medication (many of which may not be easily accessible) from a plurality of sources, the embodiments presented herein facilitate consolidation of REMS information into a single location. Further, rather than having to review a wealth of REMS information (much of which may not pertain to the prescriber), information only of interest to the prescriber can be presented. Interaction with the centralized system, and access of data stored thereon, can be by a graphical user interface (GUI) such as a webpage(s), dashboard(s), accessible via the internet.

While ensuring compliance of a prescriber with a REMS requirement, the various embodiments can further benefit a drug manufacturer by providing an opportunity for prescribers to have easier access to a REMS medication(s), increasing prescriber exposure to the drugs offered by the manufacturer, and decreasing risk and harm events associated with use of their medications by improving adherence with REMS elements of compliance and certification. Further, the various embodiments can serve as a national medication safety database data repository and output system to support efforts aimed at decreasing preventable harm and death related to the subset of drugs identified and proven to be more dangerous (e.g. REMS drugs) compared to other nationally prescribed medications.

A prescriber can create a profile and select a medication(s) they prescribe from a pre-defined list. Further, based upon user selection, a prescriber can be paired with a REMS requirement and element of compliance for each medication they selected. Also, in an embodiment, a work-list can be generated to guide a prescriber down a path to compliance along with selection of notification preferences for keeping up-to-date with REMS program changes. The work-list can be prioritized to facilitate effective compliance with one or more REMS regulation.

In another embodiment, a drug manufacturer may use the tool to verify that a prescriber has met the certification requirements for a REMS medication. In another embodiment, a data-feed organization may utilize the centralized REMS information system to export REMS data stored thereon to another party, such as a medical publisher, an associated electronic medical system, and the like.

The various, exemplary, non-limiting embodiments are now described with reference to the drawings, wherein like reference numerals are used to refer to like elements throughout. It is to be appreciated that while the various exemplary, non-limiting embodiments presented herein relate to REMS compliance, the various embodiments are not so limited and are applicable to any application regarding medical/medication compliance. It is also to be appreciated that for the sake of brevity and comprehension the abbreviation REMS is utilized throughout the application however the abbreviation ETASU (as previously described) is equally applicable. Furthermore, it is to be appreciated that the terms “compliance”, “regulation”, “requirement”, and the like, can be used interchangeably. Further, while the various embodiments are directed towards regulation(s) associated with a Federal entity (e.g., FDA, FDAAA), the various embodiments are not so limited and can be directed to any entity such as governmental, international, health authority, and the like.

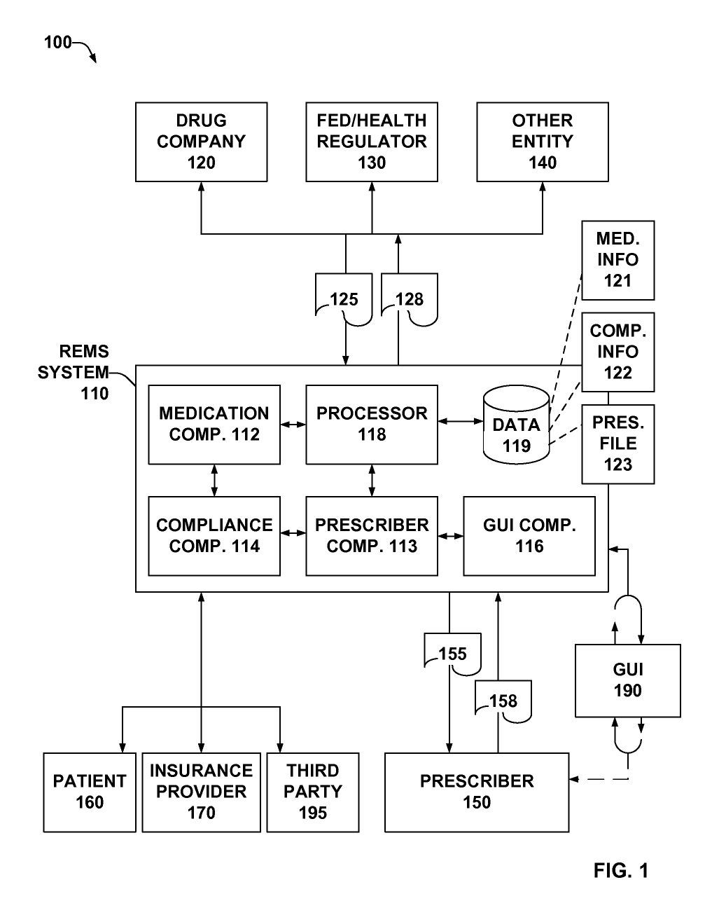

FIG. 1 illustrates an exemplary, non-limiting embodiment of system 100 to facilitate compliance with a REMS requirement. System 100 comprises a central component, REMS system 110, which can be utilized to receive information from a medication manufacturer, a drug company 120, a regulation generated by a government entity or other organization associated with REMS compliance, a federal/health regulator 130, and any other entity 140 associated with REMS compliance. A prescriber 150 can be associated with the REMS system 110, whereby a REMS compliance information 125 can be received at the REMS system 110 to facilitate various interactive tasks with the REMS compliance information 125 by the prescriber 150.

A drug company 120 can include any medication manufacturer, or associated entity, and can, in an embodiment, utilize the REMS system 110 to issue compliance regulations, etc., and based thereon, certify that a prescriber 150 has met the certification requirements for a REMS medication (e.g., to facilitate supplying one or more medications to a prescriber).

In this embodiment, a prescriber 150 can include any entity utilizing REMS system 110 and can include an individual prescriber(s), a physician, a nurse practitioner, a medical resident, a medical professional, a health care organization(s) (e.g., a hospital), a pharmacy, etc. In an embodiment, a healthcare facility has access to the REMS system 110 to facilitate overseeing or aiding an affiliated prescriber (e.g., a physician at a medical facility) in keeping track of their compliance with a REMS requirement(s). In another embodiment, a pharmacy, which may have responsibility or liability for only dispensing REMS medications when a certified prescriber has prescribed the medications, may use the REMS system 110 to verify compliance with the REMS requirements prior to dispensing the REMS medication.

Based upon compliance regulations (e.g., as effected by federal regulator 130) a drug company 120 can generate information regarding a medication, a REMS compliance information 125, which is forwarded to the REMS system 110. The REMS information 125 can comprise of any information regarding one or more medications, where such information can include information regarding a medication, medication dosage, drug interaction, training requirement, handling requirement, certification requirement, re-certification requirement, removal of REMS regulations for the medication, addition of the medication to REMS compliance, and other information related to REMS compliance and regulation.

The REMS information 125 can be received at the REMS system 110. The REMS system 110 can comprise of any components, applications, software, etc., to facilitate receipt, interpretation, analysis, information generation, information dissemination, etc., where such components, applications, etc., can include a medication component 112, a prescriber component 113, a compliance component 114, a graphical user interface (GUI) component 116, and any associated processor(s) 118 and data store(s) 119. The data store 119 can store any information associated with operation of the REMS system 110 to facilitate effective utilization of the REMS system 110 by a drug company 120, a federal/health regulator 130, an other entity 140, a prescriber 150, a patient 160, an insurance provider 170, a third party data feed 195, etc. In an embodiment, a data store 119 can store a list of medications 121, a compliance information 122, a prescriber information 123, and the like.

In an exemplary scenario, REMS information 125 can be received at a REMS system 110 and acted upon by a medication component 112, whereby the medication component 112 can review (e.g., by performing an analyzing operation, a parsing operation, and the like) the content of the REMS information 125 to determine which medication(s) is associated with the REMS information 125. A list of medications 121 can be stored in a data store 119, where a medication list 121 can comprise of the entirety of medications available for prescription, or a subset, where the subset can be based on a medication having a REMS requirement (either current or previous), a medication relating to a particular physician/prescriber specialty, etc. In an embodiment, the list of medications 121 (and associated compliance information 122) can be updated in collaboration with a drug company 120 to facilitate accurate and shareable data regarding a medication(s) manufactured by a drug company 120 and accordingly ensuring compliance for dispensing particular REMS drugs.

Based upon identification of a medication, a compliance component 114 can be utilized to retrieve any existing compliance information 122 relating to the medication, e.g., as stored on a data store 119. A compliance component 114 can identify the status of any existing compliance information 122 with reference to any compliance information received in a REMS information 125, and in the event of new compliance information being received, the existing compliance information 122 can be updated accordingly. Further, if the REMS information 125 is directed towards a medication not in the medication list 121, the medication can be added to the medication list 121 and compliance information added to the compliance information 122.

A REMS system 110, e.g., in accordance with a medication component 112 and/or a compliance component 114, can notify a prescriber 150 of the newly received compliance information. Notification can be by any suitable means such as email, a notice directed to a prescriber 150 on a GUI 190 of the REMS system 110, a text message, or other electronic means. As further described herein, in an embodiment, a GUI 190 can be utilized to facilitate interaction between a prescriber 150, the REMS system 110, and ultimately any of a drug company 120, a federal/health regulator 130, or an other entity 140, etc. Utilization of a GUI 190 enables an interface (e.g., a website, a webpage, an interactive webpage, etc.) to be generated either of a general nature, or specific to the requirements of a particular prescriber 150. Hence, rather than REMS related information being distributed across a plurality of individual websites on the internet (e.g., at each drug manufacturers website), all available REMS related information can be presented on a GUI 190 or as a direct download hosted thereon. In another embodiment, the GUI 190 provides links to REMS related information on third party internet websites.

In an embodiment, during initial engagement between a prescriber 150 and a REMS system 110, a questionnaire 155 can be transmitted from the REMS system 110 to the prescriber 150. Such questionnaire 155 may comprise questions, regarding the prescriber's 150 practice, such as their function or title, field of practice, specialty within the field, medications typically prescribed/of interest, and conditions typically treated or of interest. Further, questions may include contact information, employer, hospital or medical facility affiliations or “rights,” and a unique identifier such as the prescribers 150 national provider information (NPI)/Drug Enforcement Administration (DEA) number/state licensure (e.g., to facilitate unique identification between each of the prescribers 150 engaged with the REMS system 150). In response to receiving the questionnaire 155, the prescriber 150 can self-complete and forward a completed response 158 providing their pertinent details.

Upon receipt of the response 158 comprising information about the prescriber 150, a prescriber component 113 can be utilized to generate a prescriber profile 123 which comprises information pertinent to the prescriber 150, where such information can be utilized by a GUI component 116 to generate/update an interface(s) (e.g., GUI 190) to facilitate interaction between the REMS system 110 and the prescriber 150. For example, the prescriber profile 123 can contain information regarding how a webpage associated with the GUI 190 is to be formatted with regard to font, color, content. In an embodiment, a prescriber 150 can be a healthcare organization, such as a hospital, whereby the healthcare organization enables its logo to be displayed on a webpage associated with their data thereby indicating that the healthcare organization supports REMS compliance of the facility and anyone associated with the organization (e.g., a physician at an affiliated medical center).

Based on information provided in the response 158 (and any supplemental information) the GUI 190 can be configured in accordance with utilization requirements of the prescriber 150. For example, based upon a list of medications identified as being prescribed by/of interest to prescriber 150, the GUI 190 can be configured to present information regarding those medications. For example, if new information is received in the REMS information 125, the GUI 190 can be configured to present the new information, and/or provide notification that new information regarding a particular medication is available. Thus, the prescriber 150 can view the new information directly on the GUI 190, follow a link on the GUI 190 to the information, and/or request the new information (e.g., via checkbox or other interactive means) be displayed or emailed. As indicated by the broken lines between the prescriber 150, the GUI 190 and the REMS system 110, any information can be conveyed, viewed, responded to, etc., at any time on the GUI 190 to facilitate timely generation, interaction, and review of REMS related information between the prescriber 150 and the REMS system 110. The GUI 190 can be configured to display one or more tasks, which when completed by the prescriber 150, enable the prescriber 150 to complete the task(s) and progress toward completing any necessary REMS requirements to facilitate achieving certification/compliance. Further, owing to a prescriber 150 self-completing compliance-related information (e.g., via feedback 158 and/or GUI 190) it is considered that the information provided will have a high level of veracity owing to the prescriber 150 providing the information themselves and taking the time to go through a step-by-step approach. Further, any information provided or accessed by prescriber 150, via REMS system 110, can be date-time stamped to facilitate auditing, if necessary. Further, review of the prescriber information 158 and the various REMS regulations 125 can be performed at any time, such as at a pre-defined time interval (e.g., hourly, daily, weekly, or monthly), or at any other time to facilitate timely compliance with one or more REMS regulations. Tasks presented on GUI 190 can include providing a medication guide, a patient informed consent requirement, provision of a patient counseling document, an appropriate use checklist, obtaining one or more certifications, enrolling a patient in a program such as a course of medication or monitoring, enrolling a facility into a required course, provisioning clinical information, and the like.

Along with the prescriber 150, other entities can be further associated with REMS system 110 such as a patient 160, an insurance provider 170, or a third party data feed 195, who can view or retrieve various REMS information stored at REMS system 110 as necessary. Furthermore, it is to be appreciated that a requestor of information from the REMS system 110 can be any of a prescriber 150, a drug company 120, a federal/health regulator 130, an other entity 140, a patient 160, an insurance provider 170, or other third party 195. In the various embodiments, information (e.g., a REMS regulation 125, a response 158, and any other supplemental information) can be provided to the REMS system 110, e.g., by a drug company 120, and a federal/health regulator 130, an other entity 140, a prescriber 150 a patient 160, an insurance provider 170, or other third party 195, and similarly, information (e.g., operational information 128, webpages presented on GUI 190, etc.) can be requested and viewed by a drug company 120, and a federal/health regulator 130, an other entity 140, a prescriber 150 a patient 160, an insurance provider 170, or other third party 195.

In an embodiment, the REMS system 110 can be configured such that different entities associated with the REMS system 110 can have different levels of access and information accordingly provided. For example, a prescriber 150 can be provided with a high level of access enabling full querying/viewing of any information associated with the prescriber 150. Alternatively, a patient 160 may be accorded low level access and is thus only able to query/view a limited amount of information regarding a particular prescriber 150. For example, a patient 160 (e.g., via a website or similar interface) may only be able to query/view information regarding the compliance of the prescriber 150 with regard to a particular medication as a means for answering a question such as “Is my doctor in REMS compliance regarding drug x? and if not, who in my locality is?” In another aspect, an insurance provider 170 may have sufficient level of access to facilitate querying the REMS system 110 to determine a level of REMS compliance of a prescriber 150 for a particular medication. Such a query can be of use when reviewing an incident of medical malpractice (e.g., by a lawyer), determining insurance coverage and cost for a prescriber 150, whereby, for example, a lower premium can be charged for a prescriber 150 being in compliance rather than one that is not.

Further, a drug company 120, a federal/health regulator 130, or an other entity 140 can obtain operational information 128 from a REMS system 110. In an embodiment, the operational information 128 can be utilized to indicate how successfully the REMS system 110 is operating in terms of degree of REMS compliance by one or more prescribers 150, a success of implementation of a given REMS regulation (e.g., in a REMS regulation 125 submitted by a drug company 120), and the like. For example, there may be reluctance or lack of perception in the benefit of applying a REMS regulation by a prescriber. However, the reluctance to expend time and/or money on complying with a REMS regulation may be a function of the difficulties encountered with current approaches to obtaining REMS regulation information. Operational information 128 can be obtained to identify REMS compliance by one or more prescribers 150, for example, increase in REMS compliance based on utilization of the REMS system 110, REMS compliance based on a new regulation (e.g., regulation 125) being initiated by a drug company 120, a federal/health regulator 130, or other entity 140, or REMS compliance based on a new training regimen initiated by drug company 120.

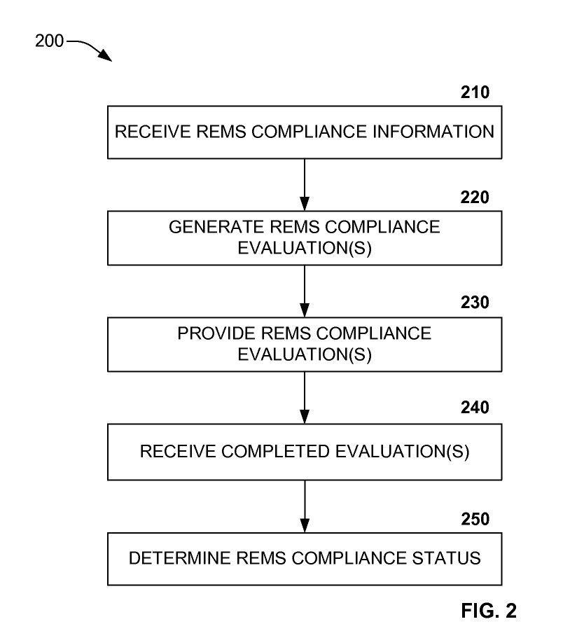

FIGS. 2-12 illustrate exemplary methodologies relating to provisioning REMS compliance. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement the methodologies described herein.

FIG. 2 illustrates a methodology 200 for gathering, compiling and disseminating REMS compliance information. At 210 REMS compliance information is received at a centralized system configured to store and provide REMS compliance information and actions. As previously mentioned, a large number of medications have one or more REMS requirements associated therewith, whereby the number of medications requiring REMS compliance can change at any time, the content of the REMS requirements can change at any time, and further, REMS compliance information can be provided by a plurality of sources, rather than a single source. A centralized system enables all of the REMS compliance regulations and information that a prescriber may have to comply with to be provided from a single source rather than the prescriber having to track down the REMS compliance information themselves.

At 220, the various REMS compliance regulations and information can be compiled, e.g., for each medication requiring REMS compliance, in accord with ETASU or other requirement/regulation. For each medication with REMS elements of compliance, a REMS compliance questionnaire can be generated to facilitate evaluation of a prescribing entity's ability to meet a requirement(s) for REMS compliance for the medication.

At 230, the REMS compliance questionnaire can be provided to the prescriber. The questionnaire can be provided in the form of an interactive webpage(s) comprising various data fields which the prescriber can accordingly complete.

At 240, the completed REMS compliance questionnaire can be received at the centralized system from the prescriber.

At 250, based on the completed REMS compliance questionnaire in conjunction with the requirement(s)/regulation(s) pertaining to a medication, the REMS compliance of the prescriber can be evaluated. As described herein, if a prescriber fails to satisfy a particular REMS requirement, the prescriber can be tasked with one or more actions to facilitate compliance, whereby the REMS system can monitor adherence and prescriber activity as they are directed towards being compliant.

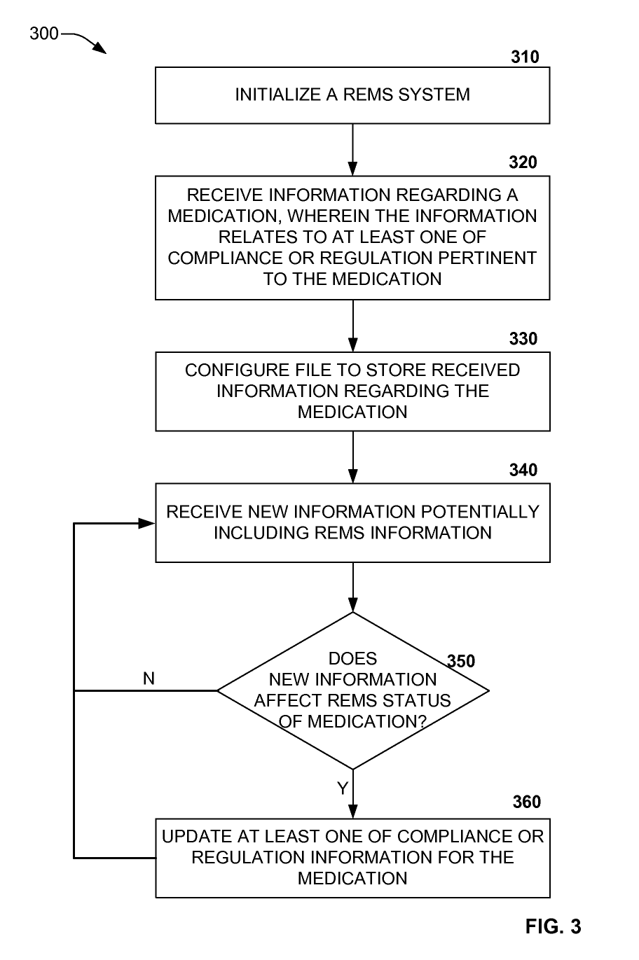

FIG. 3 illustrates a methodology 300 for receiving REMS compliance information and based thereon, maintaining a centralized REMS information system. At 310, a REMS compliance system can be initialized. As previously mentioned, the REMS system can act as a centralized repository for any information regarding REMS compliance, e.g., REMS compliance regulations received from a drug manufacturer, addition of a medication to REMS compliance, removal of a medication from REMS compliance, or a federal mandate.

At 320, information is received at the REMS system regarding REMS compliance for a medication.

At 330, the received information can be analyzed and a file generated for the medication, where the generated file can store any information pertinent to the medication, such as one or more REMS regulations associated with the medication and any activities required to facilitate compliance with the REMS regulation(s).

At 340, new information can be received, whereby the new information can potentially include REMS compliance information for the medication, or other medication stored in the REMS compliance repository.

At 350, upon receipt of the new information, the information can be analyzed, e.g., parsed, to determine whether the information includes REMS information pertinent to any of the medication(s) stored in the REMS compliance repository. If a determination is made that the information does not contain any information pertinent to the medication, flow returns to 340 to await receipt of the next information.

At 360, if a determination is made that the information contains information pertinent to the medication the REMS compliance information for the medication is updated in accord with the newly received information. Further, the newly received information can contain information regarding a medication that is not currently stored in the REMS compliance repository (e.g., the medication is newly available, has recently been indicated as requiring REMS compliance, etc.), whereupon a file for the new medication can be added to the REMS compliance repository. Flow returns to 340 for new information to be received.

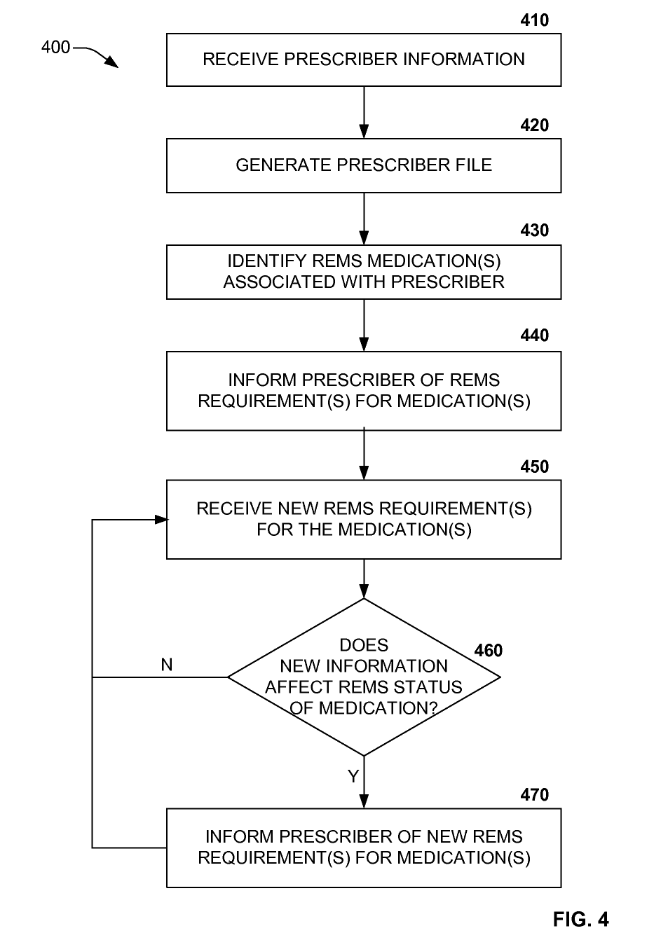

FIG. 4 illustrates a methodology 400 for providing a prescriber with REMS compliance information. At 410, a request from a prescriber to join the REMS compliance system can be initialized. The request can include any information pertinent to the prescriber as required to facilitate generation of a prescriber file and also to facilitate monitoring of the prescribers compliance with any pertinent REMS regulations. At 420, based on the received information, a prescriber profile can be generated.

At 430, as part of the subscribing operation the prescriber can select/submit which medications they prescribe. Further, as described herein, one or more medications can be associated with a specialty of a prescriber.

At 440, the list of selected/submitted medications can be reviewed and any REMS compliance information for each medication can be presented/forwarded to the prescriber (e.g., by email, GUI, text message).

At 450, new information regarding REMS compliance for one or more medications can be received.

At 460, a determination can be made regarding whether the new information affects the status of a medication identified as being of interest to the prescriber. If no new information pertains to the medication(s) of interest to the prescriber, the flow returns to 450.

At 470, based on the new information comprising REMS compliance information pertaining to a medication of interest to the prescriber, the prescriber can be informed of the new REMS compliance information being available. In an embodiment, the prescriber can be accessing the REMS system via a GUI, and in such an event, a notification can be placed on the GUI indicating that new REMS information is available, the information can be provided in its entirety, a link with an address to a page comprising the new information can be provided or an email sent.

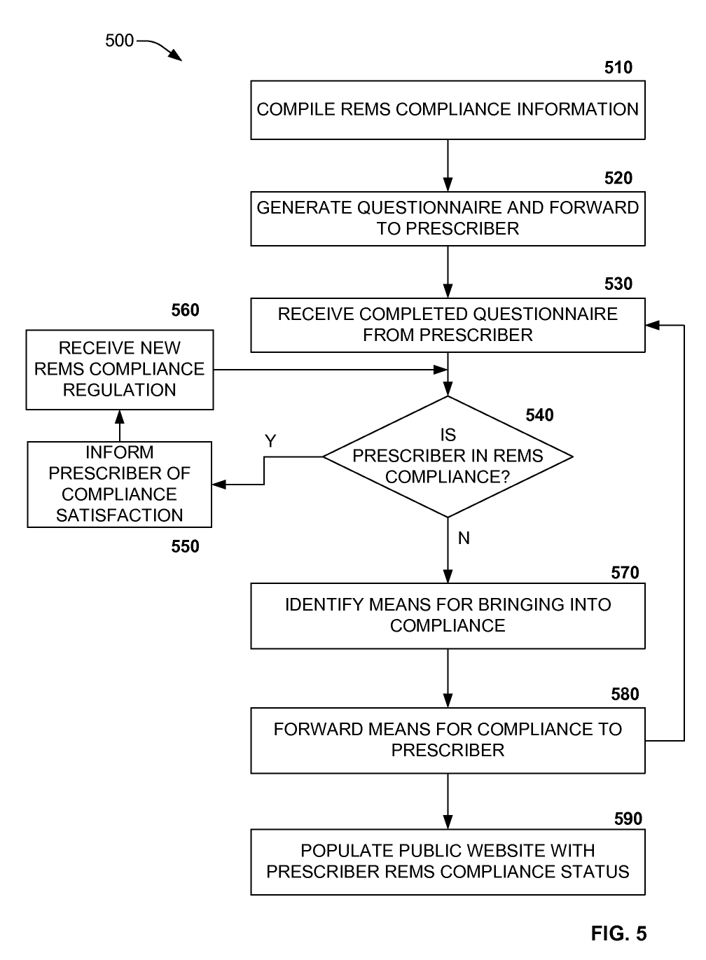

FIG. 5 illustrates a methodology 500 for assisting a prescriber in establishing and/or maintaining compliance with at least one REMS requirement or regulation. At 510, REMS compliance information is compiled, where such information can include a requirement for compliance as generated by a manufacturer of a medication, as previously mentioned.

At 520, based on the REMS compliance information, a questionnaire can be forwarded to a prescriber (e.g., based on the medication(s) identified as being of interest/prescribed by the prescriber). The questionnaire can be presented in the form of a webpage in a GUI.

At 530, the completed questionnaire is received from the prescriber.

At 540, the response(s) entered in the questionnaire can be compared with the REMS compliance information for each medication identified as being prescribed/of interest to the prescriber. Based thereon, a determination can be made with regard to whether the prescriber is in compliance with one or more regulations relating to one or more medications.

At 550, in the event of being in compliance, the prescriber can be informed of compliance satisfaction. It is to be appreciated that the prescriber may be in compliance with regard to a regulation(s) pertaining to particular medication and out of compliance with regard to another regulation(s). Hence, a report can be compiled and comprise of information directed to each of the medication(s)/regulation(s), and can indicate compliance with one regulation and out of compliance with another.

At 560, a new REMS compliance regulation can be received, e.g., a new medication has been added to the REMS compliance list, there has been an update to a REMS compliance regulation, etc. Flow returns to 540 for determination of whether the prescriber is in compliance based on the newly received compliance.

At 570, in the event of the prescriber being determined to not be in compliance with at least one REMS compliance regulation, at least one means for satisfying the out of compliance REMS regulation can be determined. Any suitable means can be determined, for example, forwarding medical information (for example, a medical guide) to the prescriber regarding a particular medication to enable the prescriber's information base to be brought into conformity with the regulation (e.g., information base comprises of required information), a physician or other entity associated with the prescriber can undergo training to obtain specific experience/knowledge required for a medication(s), indicate they can diagnose a condition for which the medication is directed towards, they understand the risks and benefits of a medication, they have read educational materials associated with the medication, they can diagnose and treat a potential adverse reaction to the medication, they periodically recertify and re-enroll in an ETASU/REMS program, they agree to terms of a prescription (e.g., required to receive prior-authorization, check ‘qualification stickers’, dispense within a pre-determined amount of time, complete prescriptions only from an enrolled physician, conduct patient monitoring, etc.), and the like.

At 580, at least one means for satisfying the out of compliance REMS regulation can be forwarded to the prescriber, e.g., by email or notification via an interactive GUI.

At 590, while the various REMS compliance information can be directed towards the prescriber, REMS compliance information pertinent to the prescriber can be made available to other entities. For example, a summary can be provided on a webpage associated with the prescriber whereby a patient (or other member of the public) can view the webpage to identify whether the prescriber is in REMS compliance regarding at least one medication.

FIG. 6 illustrates a methodology 600 for disseminating REMS compliance information. At 610, as previously mentioned, a REMS compliance system can act as a centralized repository of REMS compliance regulations and information. Accordingly, the REMS compliance regulations/information can be provided to any interested party. A request can be received for REMS information, for example, from a third party (e.g., a data-feed organization) associated with generation of medical literature.

At 620, based upon the received request, REMS information pertinent to the request can be identified. For example, a request may be for REMS information associated with a particular medication, whereby a data store associated with the REMS compliance system can be queried and any information relating to the medication of interest can be retrieved.

At 630, the requested information can be forwarded to other parties having an interest in the medication (e.g., a medical publisher).

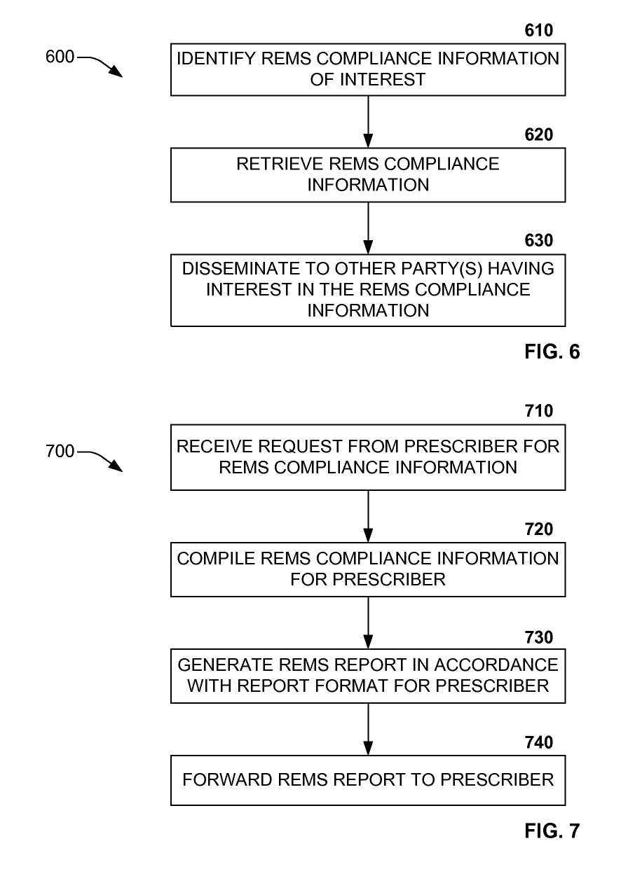

FIG. 7 illustrates a methodology 700 for generating a REMS compliance report. At 710, a request can be received from a prescriber regarding their REMS compliance. For example, as part of an internal audit, a prescriber pharmacy is required to provide REMS compliance information regulations and information. Accordingly, the prescriber can generate a request for their compliance information (e.g., for the various physicians and other medical personnel) associated with the prescriber.

At 720, in response to the request, the REMS compliance information for the prescriber can be retrieved, e.g., from a data store associated with the REMS compliance system.

At 730, a report can be compiled for the REMS compliance information for the prescriber. For example, information can be provided regarding which REMS regulations are satisfied, which REMS regulations are not, what is being done to remedy a lack of compliance, etc. As previously mentioned, the prescriber can indicate how their report is to be formatted with regard to content, color, graphics (e.g. prescriber logo), etc.

At 740, the REMS compliance report can be provided to the prescriber.

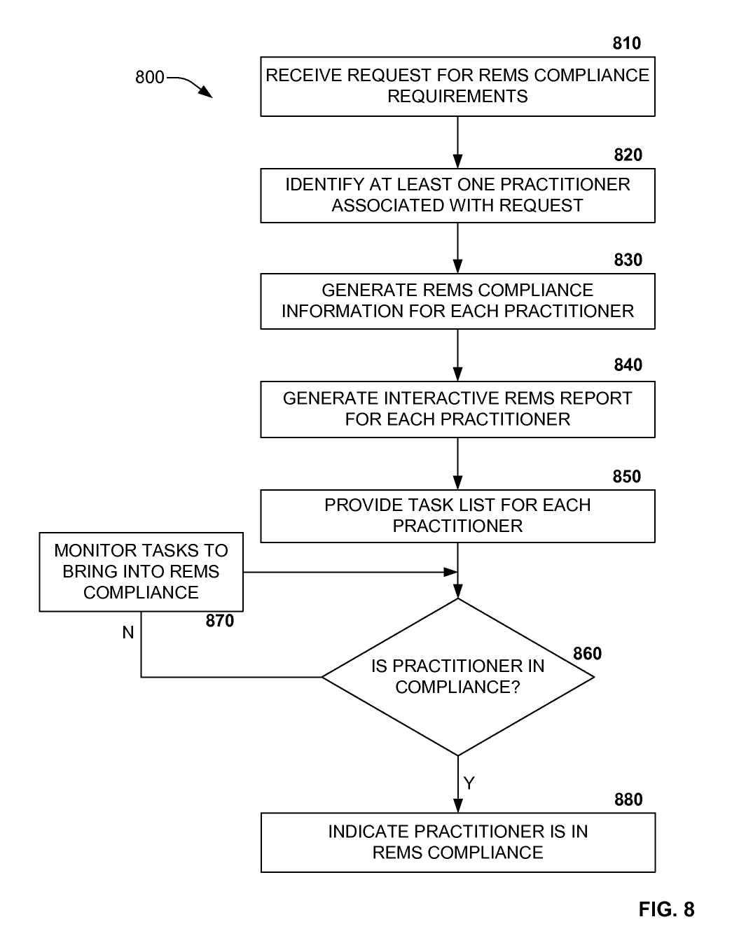

FIG. 8 illustrates a methodology 800 for provisioning a REMS compliance system to an individual practitioner, e.g., a physician with a solo practice, an individual operating in association with a prescriber organization such as physician at a hospital, etc. At 810, a request can be received from an individual regarding their REMS compliance. Similarly, the request can be generated by a prescriber organization on behalf of the individual, e.g., on behalf of the physician.

At 820, at least one practitioner associated with the request is identified.

At 830, REMS compliance information for each practitioner is generated, whereby information can be generated based on unique identification of the practitioner, e.g., based on their DEA number, NPI number, state licensure.

At 840, a REMS compliance report is compiled for the practitioner. The report can be of an interactive nature (e.g., as a webpage supported by the REMS system, a webpage generated by an application local to the prescriber/physician, etc.), which enables the practitioner to enter information regarding their REMS compliance activities.

At 850, a task-list regarding the various REMS compliance regulations can be generated.

At 860, based on the task list, a determination can be made regarding whether the practitioner is in compliance, e.g., has the practitioner received certain training such as does the practitioner have specific experience/knowledge required to prescribe a medication(s), can they diagnose a condition for which the medication is directed towards, do they understand the risks and benefits of a medication, have they read the educational materials associated with the medication, can they diagnose and treat a potential adverse reaction to the medication, they communicate with a patient the risks and benefits regarding a particular medication, they periodically recertify and re-enroll in an ETASU/REMS program, they agree to terms of a prescription (e.g., required to receive prior-authorization, check ‘qualification stickers’, authorize the dispensing of a medication within a pre-determined amount of time), conduct patient monitoring, does the practitioner's operation meet REMS regulations?, and the like.

At 870, based on a determination that the practitioner is not in compliance with at least one regulation, an associated task can be identified, and based upon completion of the task the flow returns to 860 to re-evaluate the practitioner's REMS compliance status.

At 880, based upon a determination that the practitioner is in compliance with the at least one regulation, an indication can be presented/forwarded to the practitioner indicating their compliance.

FIG. 9 illustrates a methodology 900 for prioritizing a task-list of activities to facilitate effective REMS compliance. As previously mentioned, based on feedback from a prescriber, a level of compliance with one or more REMS regulations can be determined for the prescriber. At 910, a plurality of REMS compliance regulations can be identified that the prescriber has failed to satisfy. Identification of REMS compliance regulations for which an activity is to be conducted by a prescriber can be performed at any time. For example, upon initial registration with the REMS system, the prescriber information provided at registration can be reviewed and REMS compliance activity identified. Alternatively, as a new REMS regulation is received, e.g., from a drug manufacturer, the supplied prescriber information can be reviewed to identify whether the newly received REMS regulation places the prescriber out of compliance. Further, review of the prescriber information and the various REMS regulations can be performed at any time, such as at a pre-defined time interval (e.g., hourly, daily, weekly, monthly), or at any other time.

At 920, a work-list of activities can be generated to be performed by the prescriber to facilitate satisfying the one or more regulations to bring the prescriber into compliance with the one or more REMS regulations.

At 930, the work-list of activities can be prioritized. Prioritization can be based on one or more factors, for example, whether the medication is an ETASU/non-ETASU medication, a severity of risk associated with the medication (e.g., risk to a patient), risk of audit by a drug manufacturer, a federal organization (e.g., the FDA), or other entity associated with effecting REMS compliance, and whether performing an activity can facilitate meeting a plurality of REMS requirements simultaneously.

At 940, the work-list can be provided to the prescriber, whereupon the prescriber can perform the various activities to facilitate their complying with the plurality of the REMS requirements, as previously described. As the one or more activities are performed and the associated REMS requirement satisfied, notification of the activity being performed can be forwarded to the REMS system to update the prescriber REMS compliance file at the REMS system.

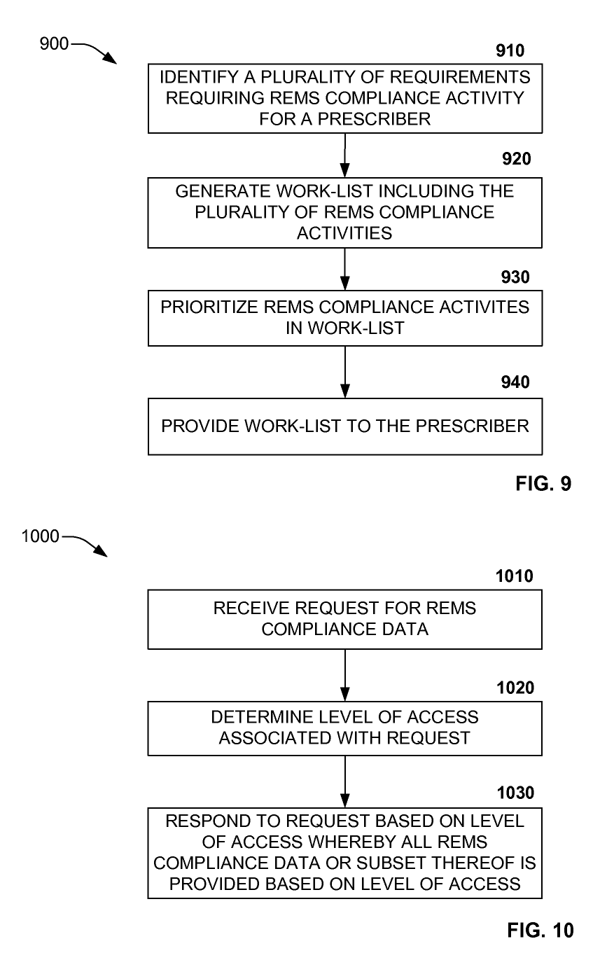

FIG. 10 illustrates a methodology 1000 for provisioning REMS compliance information to a plurality of entities based upon access level. For the various entities that may require information regarding at least one REMS compliance regulation, different access levels can be established based upon, for example, the level of interaction or information source. For example, a prescriber can be assigned a high level of access owing the sensitivity of information they are likely to provide to a REMS compliance system and according interaction with the REMS compliance system, information provided/stored by the REMS compliance system, etc. Alternatively, a member of the public may require information regarding the REMS compliance status of a prescriber, e.g., a prescriber affiliated medical facility, an employer of a prescriber, or a pharmacy, and hence may only be given low level access, such as being able to only view information regarding compliance of a prescriber, whereby the information may be viewable by a rudimentary search based on keywords such as prescriber, location, and the like. At 1010, a request can be received from an individual regarding their REMS compliance. Similarly, the request can be generated by an organization (e.g. hospital) on behalf of the prescriber/individual, e.g., on behalf of the physician.

At 1020, an access level associated with the request is determined (e.g., by an authentication and authorization process). As mentioned, if the request has a high level of access (e.g., the requesting entity is a prescriber) then the requesting entity is provisioned greater access than another entity, such as an attorney, accessing the REMS system for an issue associated with an incident of medical malpractice. In a further example, a member of the public who is interacting with the REMS system (e.g., via an online application) may not have to provide any authentication and interacts with the REMS as a visitor.

At 1030, a response to the request is generated based on the access level with all of the information made available (e.g., for a high level access) or a subset thereof (e.g., for visitor access, low-mid level access).

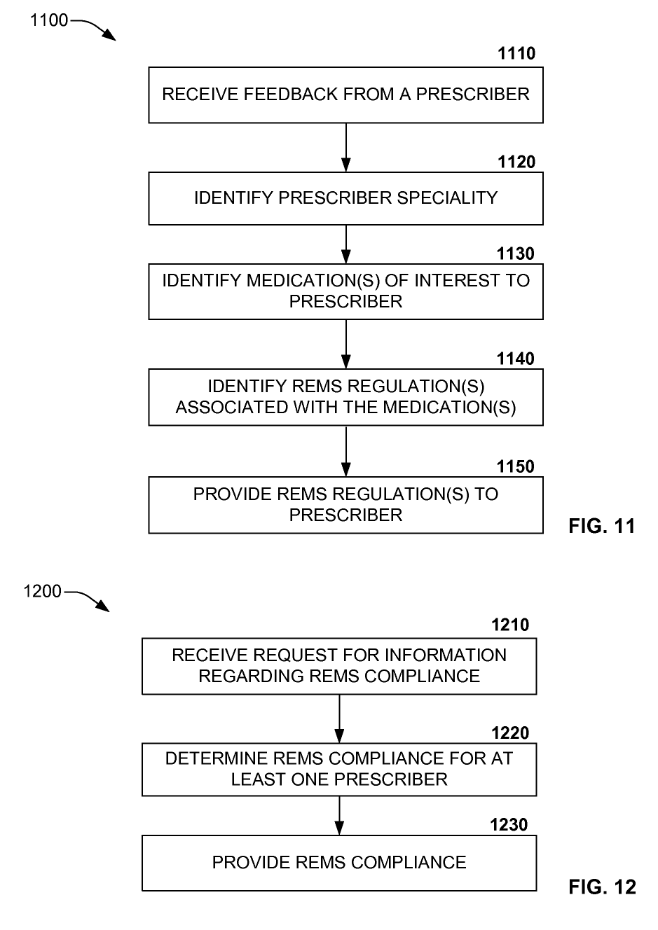

FIG. 11 illustrates a methodology 1100 for provisioning REMS compliance information based on prescriber specialty. At 1110, as previously described, during registration with a REMS system (or at any other time), a prescriber can provide information regarding their specialty.

At 1120, the prescriber specialty can be identified, for example, one prescriber could be an ophthalmologist, while another prescriber can be involved with sports medicine.

At 1130, based at least on the prescriber specialty, one or more medications can be identified as being of possible interest to the prescriber. For example, a specific type of analgesic may be of potential interest to the sports medicine prescriber, where the potential interest can be determined based on number of other sports medicine prescribers also prescribing the specific analgesic. The medications that may be presented to a prescriber of a designated specialty may be determined by data gathered by the REMS system from the questionnaire responses of prescribers of the same speciality, and the medications that they list as being typically prescribed or of interest. At 1140, REMS regulations pertaining to the one or more medications can be identified, e.g., for the specific analgesic.

At 1150, the identified REMS regulations can be forwarded to the prescriber.

FIG. 12 illustrates a methodology 1200 for provisioning REMS compliance information. At 1210, a request can be received at a REMS system for operational information regarding compliance of one or more prescribers with a REMS regulation(s). The request can be generated by any entity such as a drug company, a federal regulator, or a health regulator. The operational information can be utilized to facilitate a determination of how successfully the REMS system is operating with regard to REMS compliance by one or more prescribers, success of implementation of a given REMS regulation (e.g., a REMS regulation submitted by a drug company), or to ensure compliance with REMS regulations.

At 1220, REMS compliance for at least one prescriber can be determined. For example, quantification can be obtained indicating how many prescribers are in compliance with a REMS regulation(s) (e.g., total number, percentage, etc.). By quantifying compliance with one or more REMS regulations a determination can be made regarding the effectiveness of a particular regulation, ease with which the regulation can be complied with, a change in REMS compliance based on availability of a REMS system, REMS compliance based on a new regulation being initiated (e.g., by a drug company, a federal regulator, a health regulator, or other entity), change in REMS compliance based on a new training regimen being initiated by a drug company, and the like. For example, a requestor may use compliance information and reports to compare against medication error and harm data in order to make determinations, assumptions and/or correlations between level/percent compliance and level/percent harm events associated with a REMS medication(s).

At 1230, a feedback report can be generated presenting the various REMS compliance data and subsequently provided to the requesting entity.

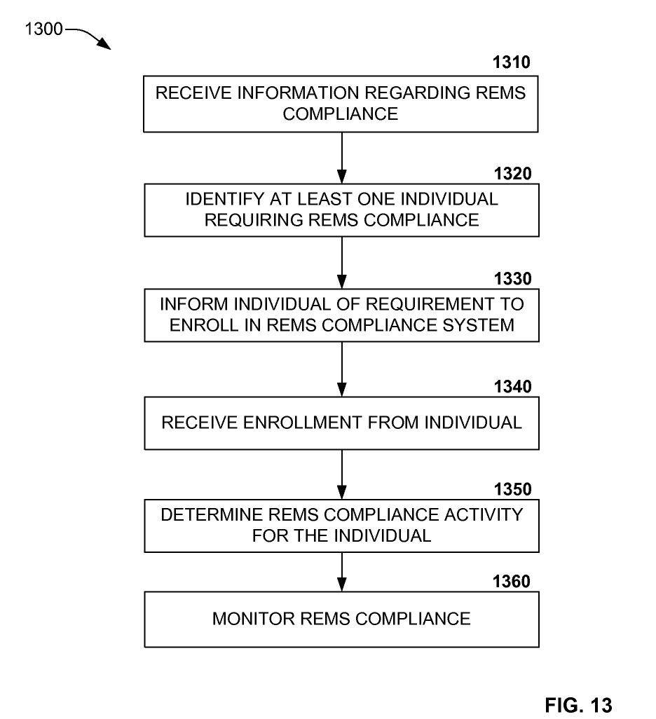

FIG. 13 illustrates a methodology 1300 for monitoring and provisioning REMS compliance information. At 1310, information can be received at a REMS system from a prescriber. In an embodiment, where the prescriber is a health organization (e.g., a hospital), the information can include a list of all of the medical personnel associated with the health organization who may be involved with the prescribing/utilization of one or more medications having some form of REMS compliance.

At 1320, the various medical personnel presented in the list can be identified.

At 1330, the various medical personnel can be informed, e.g., by email, online notification, and the like, of a requirement to engage in a REMS compliance program.

At 1340, enrollment information can be received from the various medical personnel, thereby enabling an individual approach to monitoring/enabling REMS compliance for one or more medical personnel associated with a health organization. Hence, while the health organization may initiate engagement with a REMS system, any activity including enrollment, monitoring, and facilitating REMS compliance can be conducted at an individual level.

At 1350, as the various individuals engagement in the REMS compliance system, one or more REMS compliance activity can be determined for each individual (for example, based on the individual's specialty, list of medications indicated that the individual may prescribe, etc.).

At 1360, ongoing monitoring of the individual's REMS compliance activity can be performed to facilitate the individual satisfying the REMS compliance, as well as enabling information gathered from a plurality of individuals to enable determination of REMS compliance at the health organization, at a county level, state level, national level, global level, etc., as previously mentioned with reference to FIG. 12. For example, the utilization activity of an enrolled prescriber, such as a download activity of one or more individuals can be monitored, whereby the total number of downloads from a REMS system by individual and also by prescriber, health organization, nationally, etc., can be monitored and used as a measure of REMS compliance. While not limited to, the downloads can include downloading of any of a medication guide, an informed consent, and appropriate use checklist, etc.

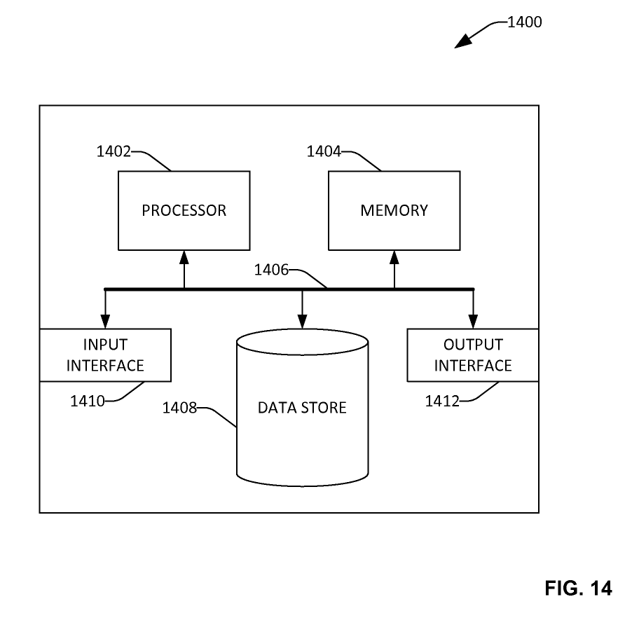

Referring now to FIG. 14, a high-level illustration of an exemplary computing device 1400 that can be used in accordance with the systems and methodologies disclosed herein is illustrated. For instance, the computing device 1400 may be used in a system to facilitate assisting a prescriber in obtaining and maintaining REMS compliance. The computing device 1400 includes at least one processor 1402 that executes instructions that are stored in a memory 1404. The instructions may be, for instance, instructions for implementing functionality described as being carried out by one or more components discussed above or instructions for implementing one or more of the methods described above. The processor 1402 may access the memory 1404 by way of a system bus 1406. In addition to storing executable instructions, the memory 1404 may also store operating parameters, required operating parameters, and so forth.

The computing device 1400 additionally includes a data store 1408 that is accessible by the processor 1402 by way of the system bus 1406. The data store 1408 may include executable instructions, operating parameters, required operating parameters, etc. The computing device 1400 also includes an input interface 1410 that allows external devices to communicate with the computing device 1400. For instance, the input interface 1410 may be used to receive instructions from an external computer device, from a user, etc. The computing device 1400 also includes an output interface 1412 that interfaces the computing device 1400 with one or more external devices. For example, the computing device 1400 may display text, images, etc. by way of the output interface 1412.

Additionally, while illustrated as a single system, it is to be understood that the computing device 1400 may be a distributed system. Thus, for instance, several devices may be in communication by way of a network connection and may collectively perform tasks described as being performed by the computing device 1400.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

The term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B.

Further, as used herein, the term “exemplary” is intended to mean “serving as an illustration or example of something”.

The articles “a”, “an”, and “the” should be interpreted to mean “one or more” unless the context clearly indicates the contrary.

What has been described above includes examples of one or more embodiments. It is, of course, not possible to describe every conceivable modification and alteration of the above structures or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A system for facilitating Risk Evaluation and Mitigation Strategies (REMS) compliance, comprising:
a computerized REMS compliance component configured to:
receive information from a prescriber, wherein the information relates to REMS compliance for a medication;
determine a REMS compliance status for the prescriber for the medication, wherein the determination is based at least in part on comparison of the received prescriber information and at least one REMS compliance regulation; and
notify a requester, based on the determination, whether the prescriber satisfies the REMS compliance regulation for the medication.

2. The system of claim 1, further comprising a medication component configured to analyze the information to facilitate determination of a medication associated with the information.

3. The system of claim 2, further comprising a data store configured to store the information determined to be associated with the medication.

4. The system of claim 1, wherein, in an event of no compliance, the REMS compliance component is further configured to identify at least one action to be performed by the prescriber to satisfy the REMS compliance regulation.

5. The system of claim 4, wherein the REMS compliance component is further configured to compile and provide a task-list to the prescriber, the requester, or both, wherein the task-list includes the at least one action.

6. The system of claim 1, wherein, in an event of no compliance, the REMS compliance component is further configured to identify a plurality of actions to be performed by the prescriber to satisfy the REMS compliance regulation.

7. The system of claim 6, wherein the REMS compliance component is further configured to prioritize the plurality of actions based on at least one of the medication has an associated Elements to Assure Safe Use (ETASU) regulation, a severity of risk associated with the medication, a risk of audit, or performing an action facilitates simultaneous compliance with a plurality of REMS compliance requirements.

8. The system of claim 1, wherein the REMS compliance component is further configured to generate REMS compliance feedback, wherein the feedback relates to at least one of identification of REMS compliance by one or more prescribers or percentage change in REMS compliance by one or more prescribers.

9. The system of claim 8, wherein the percentage change relates to at least one of generation of a new regulation or a new training regimen for compliance with a REMS regulation.

10. The system of claim 1, further comprising a graphical user interface configured to facilitate interaction with the REMS system by the prescriber.

11. A computerized method for facilitating Risk Evaluation and Mitigation Strategy (REMS) compliance, comprising:
receiving a REMS compliance requirement request from a prescriber;
based on the REMS compliance requirement request, determining a REMS compliance requirement for a medication of interest to the prescriber; and
notifying the prescriber of the REMS compliance requirement for the medication.

12. The method of claim 11, further comprising determining whether the prescriber satisfies the required REMS compliance requirement.

13. The method of claim 12, wherein in an event of the prescriber failing to satisfy the REMS compliance requirement, generating a list comprising at least one task, the at least one task facilitating satisfying the REMS compliance requirement.

14. The method of claim 12, wherein in an event of the prescriber failing to satisfy the REMS compliance requirement, generating a list comprising of a plurality of tasks, whereby the plurality of tasks are listed in order of priority.

15. The method of claim 14, wherein the order of priority is based on at least one of the medication having an associated Elements to Assure Safe Use (ETASU) regulation, a severity of risk associated with the medication, risk of audit, or performing a task facilitating meeting a plurality of REMS compliance requirements simultaneously.

16. The method of claim 12, further comprising generating REMS compliance feedback, wherein the feedback relates to quantifying REMS compliance by one or more prescribers.

17. The method of claim 11, wherein the medication of interest to the prescriber is determined by medications listed as being of interest by other prescribers practicing in a same specialty area as the prescriber.

18. A Risk Evaluation and Mitigation Strategy (REMS) compliance system comprising a memory that includes instructions that, when executed by a processor of the REMS compliance system, cause the processor to perform acts comprising:
receiving a REMS compliance requirement request from a prescriber;
based on the REMS compliance requirement request, determining a REMS compliance requirement for a medication of interest to the prescriber;
receiving information from the prescriber relating to completion of the REMS compliance requirement;
determining whether the prescriber satisfies the REMS compliance requirement for the medication; and
notifying a requester of satisfying or failing to satisfy the REMS compliance requirement for the medication.

19. The instructions of the REMS compliance system of claim 18, wherein the requester is selected from the group consisting of: a medical facility that employs or is affiliated with the prescriber, a medical organization that employs or is affiliated with the prescriber, a medication manufacturer, a patient, an insurer, a federal regulator, or a prospective patient.

20. The instructions of the REMS compliance system of claim 18, wherein in an event of the prescriber failing to satisfy the REMS compliance requirement for the medication, generating a list comprising of a plurality of tasks, whereby the plurality of tasks are listed in order of priority.
